(19) United States
(12) Patent Application Publication
(10) Pub. No.: US 2016/0182723 A1
(43) Pub. Date: Jun. 23, 2016

(54) Systems and Methodologies for Capturing Outgoing Voice Messages and Providing Secured Access Thereto

(71) Applicant: Echeaux, Inc., Austin, TX (US)

(72) Inventors: Abhay Misra, Austin, TX (US); Ajay Misra, Austin, TX (US)

(73) Assignee: Echeaux, Inc., Austin, TX (US)

(21) Appl. No.: 14/964,719

(22) Filed: Dec. 10, 2015

Related U.S. Application Data
(60) Provisional application No. 62/096,476, filed on Dec. 23, 2014.

(51) Int. Cl. H04M 3/533

(52) U.S. Cl. CPC H04M 3/533; H04M 2203/4527; H04M 2203/4536

(57) ABSTRACT

A system and associated method is provided for capturing outgoing voice messages on a mobile communications device equipped with a display and a memory device. In accordance with the system, a software program is installed in the memory device which causes a graphical user interface (GUI) to be displayed on the display thereof. The GUI enables the user to make a telephone call to a second party through appropriate input. The software program monitors the call and, when it is determined that the user is leaving a voice message on a recording device associated with the second party, the voice message is recorded on the mobile communications device.

### CROSS-REFERENCE TO RELATED APPLICATION

This application claims priority to U.S. patent application Ser. No. 62/096,476 (Abadi), entitled “SYSTEMS AND METHODOLOGIES FOR CAPTURING OUTGOING VOICE MESSAGES AND PROVIDING SECURED ACCESS THERETO,” which was filed on Dec. 23, 2014, and which is incorporated herein by reference in its entirety.

### FIELD OF THE DISCLOSURE

The present disclosure relates generally to voice messaging, and more particularly to systems and methodologies for providing for the capture of outgoing voice messages and the secured access thereto.

### BACKGROUND OF THE DISCLOSURE

Voice messaging is a routine aspect of business life. When a person to whom a call is directed is not available to take the call, voice messaging allows a caller to record a message, either on an answering machine or by way of an electronic messaging system, which typically identifies the user and the reason for the call. The use of voice messaging provides context for a missed call, and may allow the recipient to better understand the urgency of the call or to undertake suitable preparations for a return call.

### SUMMARY OF THE DISCLOSURE

In one aspect, a method is provided for capturing outgoing voice messages. The method comprises (a) displaying, on a mobile communications device equipped with a display and a memory device, a graphical user interface (GUI) which enables the user to make a telephone call; (b) in response to input on the GUI by the user identifying a second party to call, placing a call to the second party; (c) determining that the user is leaving a voice message on a recording device associated with the second party; and (d) recording the voice message on the mobile communications device.

In another aspect, a mobile communications device is provided which is equipped with a display and a tangible, non-transitory memory device. The memory device has suitable programming instructions recorded therein which, when executed by at least one computer processor, perform the steps of (a) displaying a graphical user interface (GUI) on the display which enables the user to make a telephone call; (b) in response to input by the user on the GUI identifying a second party to call, calling the second party; (c) determining that the user is leaving a voice message on a recording device associated with the second party; and (d) recording the voice message on the mobile communications device.

In a further aspect, a computer-implemented system is provided which comprises:
a. a digital processing device comprising an operating system configured to perform executable instructions and a memory;
b. a computer program including instructions executable by the digital processing device to create a voicemail management application configured to execute whenever a calling user utilizes phone calling features of the digital processing device to place a phone call to a receiving user, the application comprising:
   i. a software module configured to detect a tone generated by a voicemail system of the receiving user, the call placed by the calling user;
   ii. a software module configured to record a voicemail left by the calling user in the voicemail system of the receiving user; and
   iii. a software module configured to provide the recorded voicemail to the calling user subsequent to the call.

In still another aspect, a non-transitory, computer-readable storage media is provided. The media is encoded with a computer program including instructions executable by a processor to create a voicemail management application configured to execute, whenever a calling user utilizes phone calling features of the digital processing device to place a phone call to a receiving user, the application. The application comprises:
a. a software module configured to detect a tone generated by a voicemail system of the receiving user, the call placed by the calling user;
b. a software module configured to record a voicemail left by the calling user in the voicemail system of the receiving user; and
c. a software module configured to provide the recorded voicemail to the calling user subsequent to the call.

### BRIEF DESCRIPTION OF THE DRAWINGS

FIG. 1 is an illustration of a first embodiment of a system for capturing outgoing voice messages in accordance with the teachings herein.

FIG. 2 is an illustration of a second embodiment of a system for capturing outgoing voice messages in accordance with the teachings herein.

### DETAILED DESCRIPTION

Despite the prevalence of voice messaging, some significant shortcomings remain in these systems as currently practiced. For example, as currently practiced, a caller who leaves a voice message loses access to that message once the call is terminated. This puts the onus on the caller to remember the details of the message, should they become important later. Moreover, the supervisor of employees who frequently leave messages has no access to those messages, thus hindering his ability to effectively manage his employees.

It has now been found that the foregoing problems may be addressed with the systems, methodologies and software disclosed herein. In accordance with a preferred embodiment, software is provided, an instance of which is installed on a mobile communications device associated with a user. The mobile communications device is equipped with a display and a memory device within which the software is installed The software displays a graphical user interface (GUI) on the display which may be utilized by the user to place a call to a second party. The software monitors the call to determine when the user has been asked to leave a voice message such as, for example, by detecting a tone emitted by the message recording device associated with the second party. The software then records the subsequent message so that it may be accessed in the future by the user or an appropriately authorized party (such as, for example, the user's supervisor). In various embodiments, the recorded message may be sent to one or more designated recipients by email or text messaging, or may be stored on a server or enterprise system.

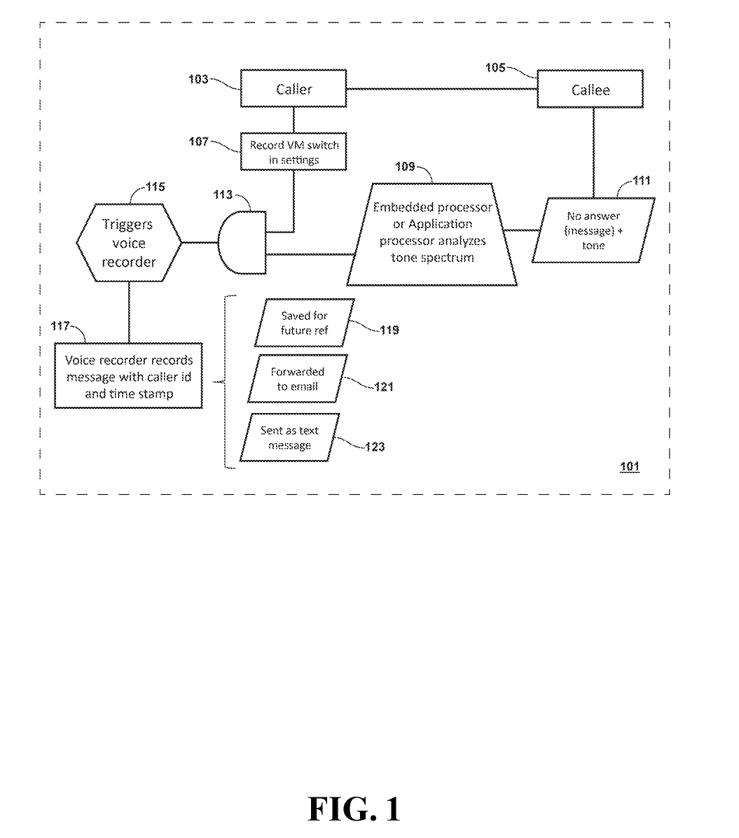

FIG. 1 is an illustration of a first particular, non-limiting embodiment of a system for capturing outgoing voice messages in accordance with the teachings herein. As seen therein, the system 101 includes a caller 103 who places a call on a mobile communications device to a second party or callee 105. The mobile communications device is equipped with a memory device and a display. The memory device has an instance of software recorded therein which displays a GUI that is utilized by the user in placing the call. The GUI may include various functionalities for this purpose including, for example, a virtual keypad which may be utilized by the user in inputting a number, an address book of contacts known to the user, a display of alphanumeric entries made by the user, and the like. The GUI also preferably includes a selectable switch 107 which the user can utilize to manually record a conversation or voice message.

The system further includes a processor 113 which monitors the call. The processor 113 includes an embedded processor or application processor 109 which analyzes the tone spectrum of the audio feed associated with the call and detects the presence of a tone 111 indicating that a recording device associated with the callee 105 has asked the caller 103 to leave a voice message. Assuming that the software has been suitably configured to permit it to do so, the processor 113 then triggers a voice recorder 115, which records the ensuing message and associates a caller ID and time stamp with it 117. Alternatively, or in situations in which no tone is provided, the user may manually select the switch 107 to record the voice message.

The software preferably includes various user selectable options which allow the user to specify what happens to a voice message after it has been recorded. These options may be accessible to the user through, for example, various menus or screens associated with the GUI.

For example, the user may configure the software so that any recorded voice message is saved for future reference 119 in a suitable memory device. Such memory device may associated with or reside on the mobile communications device itself, a computer or other such device associated with the user, or a network computer or server. The voice message may be saved in various file formats, and is preferably saved to a searchable directory or database to permit easy retrieval by the user or an authorized third party (such as, for example, the user's supervisor). For example, the user may configure the software so that any recorded voice message is forwarded by email 121 or text message 123 to one or more designated parties, either instead of, or in addition to, the foregoing options.

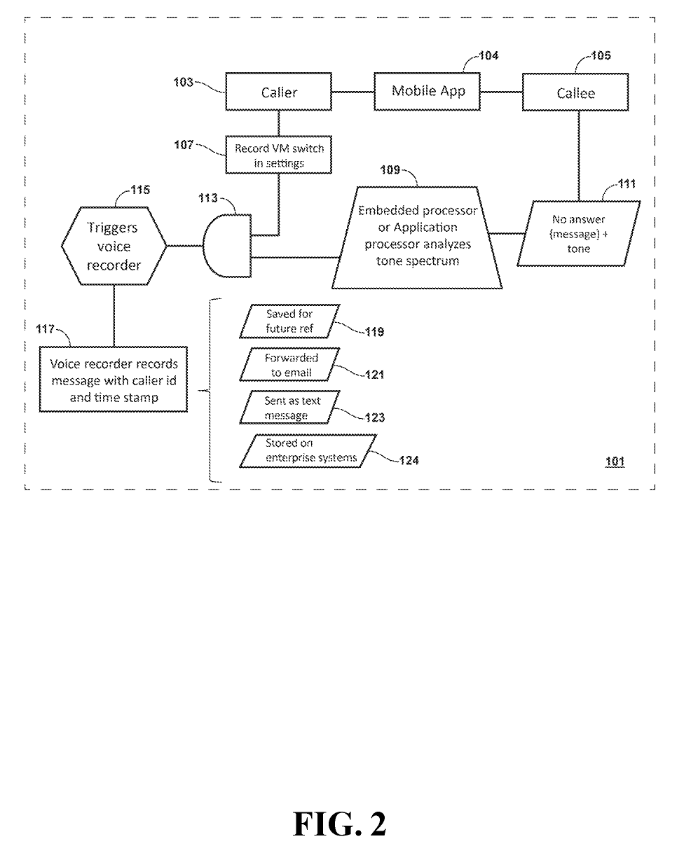

FIG. 2 depicts a second particular, non-limiting embodiment of a system in accordance with the teachings herein. This system is similar in most respects to the system of FIG. 1, but is more specifically directed to users working across an enterprise platform. While the software in the system of FIG. 1 may be a stand-alone application, in this embodiment, the software preferably takes the form of a distributed or network-based mobile application 104 which is installed on the user's mobile communications device. The mobile application 104 works similar to the software described in the system of FIG. 1, but in addition stores the recorded voice messages on an enterprise system 124 associated with a business or organization that the user is employed by or associated with. The recorded messages are preferably encrypted and password protected so that only users with the appropriate credentials can gain access to them.

The system of FIG. 2 is especially useful for applications involving a sales force or another group of employees which is under the supervision of a supervisor. The supervisor is preferably provided with suitable credentials to access the recorded voice messages, thus allowing the supervisor to, for example, track the progress of sales efforts or projects.

The systems disclosed herein may be implemented on a variety of operating systems. These include, but are not limited to, the Apple iOS™, Android™ or Windows™ operating systems. Similarly, these systems may be encoded in various programming languages or codes as are known to those skilled in the art.

Various mobile communications devices may be utilized in the systems and methodologies disclosed herein. Preferably, these devices are hand-held devices such as, for example, the mobile phones and tablets currently sold by Apple or Android, although some embodiments may also utilize laptop computers with suitable calling functionality. The term “mobile communications device” as used herein is not intended to encompass desktop computers or devices which weigh more than 8 lbs.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims. In these claims, absent an explicit teaching otherwise, any limitation in any dependent claim may be combined with any limitation in any other dependent claim without departing from the scope of the invention, even if such a combination is not explicitly set forth in any of the following claims.

What is claimed is:

1. A method for capturing outgoing voice messages, comprising:
displaying, on a mobile communications device equipped with a display and a memory device, a graphical user interface (GUI) which enables the user to make a telephone call;
in response to input on the GUI by the user identifying a second party to call, placing a call to the second party;
determining that the user is leaving a voice message on a recording device associated with the second party; and
recording the voice message on the mobile communications device.

2. The method of claim 1, wherein determining that the user is leaving a voice message on a recording device associated with the second party comprises:
monitoring the call to the second party; and
when a tone is detected on the call from the recording device associated with the second party which indicates that the user is being asked to leave a message, recording the subsequent message.

3. The method of claim 1, wherein recording the subsequent message includes associating a caller ID and time stamp with the message.

4. The method of claim 1, further comprising:
sending a copy of the recorded message to at least one designated recipient via electronic mail.

5. The method of claim 1, further comprising:
sending a copy of the recorded message to at least one designated recipient via text messaging.

6. The method of claim 1, further comprising:
storing the recorded message on a server.

7. The method of claim 6, further comprising:
providing password protected access to the stored message.

8. A tangible, non-transient medium having suitable programming instructions recorded therein which, when executed by at least one computer processor, perform the steps of claim 1.

9. A mobile communications device equipped with a display and a tangible, non-transitory memory device having suitable programming instructions recorded therein which, when executed by at least one computer processor, perform the steps of:
displaying a graphical user interface (GUI) on the display which enables the user to make a telephone call;
in response to input by the user on the GUI identifying a second party to call, calling the second party;
determining that the user is leaving a voice message on a recording device associated with the second party; and
recording the voice message on the mobile communications device.

10. The mobile communications device of claim 9, wherein determining that the user is leaving a voice message on a recording device associated with the second party comprises:
monitoring the call to the second party; and
when a tone is detected on the call from the recording device associated with the second party which indicates that the user is being asked to leave a message, recording the subsequent message.

11. The mobile communications device of claim 9, wherein recording the subsequent message includes associating a caller ID and time stamp with the message.

12. The mobile communications device of claim 9, wherein the programming instructions, when executed by at least one computer processor, further perform the step of:
sending a copy of the recorded message to at least one designated recipient via electronic mail.

13. The mobile communications device of claim 9, wherein the programming instructions, when executed by at least one computer processor, further perform the step of:
sending a copy of the recorded message to at least one designated recipient via text messaging.

14. The mobile communications device of claim 9, wherein the programming instructions, when executed by at least one computer processor, further perform the step of:
storing the recorded message on a server.

15. The mobile communications device of claim 14, wherein the programming instructions, when executed by at least one computer processor, further perform the step of:
providing password protected access to the stored message.

16. A non-transitory, computer-readable storage media encoded with a computer program including instructions executable by a processor to create a voicemail management application configured to execute whenever a calling user utilizes phone calling features of the digital processing device to place a phone call to a receiving user, the application comprising:
d. a software module configured to detect a tone generated by a voicemail system of the receiving user, the call placed by the calling user;
e. a software module configured to record a voicemail left by the calling user in the voicemail system of the receiving user; and
f. a software module configured to provide the recorded voicemail to the calling user subsequent to the call.

17. The media of claim 16, wherein the software module configured to provide the recorded voicemail to the calling user subsequent to the call provides the voicemail by saving the recorded voicemail to an archive, and wherein the archive is web-based and accessible to the calling user via the web.

18. The media of claim 16, wherein the software module configured to provide the recorded voicemail to the calling user subsequent to the call provides the voicemail by forwarding the voicemail in a format selected from the group consisting of emails and instant messages.

19. The media of claim 16, wherein the application further comprises a software module configured to provide an interface for allowing the calling user to set application preferences, the preferences comprising selection of the format in which the recorded voicemail is provided subsequent to the call.

20. The media of claim 16, wherein the application further comprises a software module configured to:
identify of the receiving user; and
provide the recorded voicemail to the calling user subsequent to the call provides the voicemail with the identity of the receiving user and a timestamp.
